(19) United States
(12) Patent Application Publication
(10) Pub. No.: US 2002/0103805 A1
(43) Pub. Date: Aug. 1, 2002

(54) Assessment system and method

(75) Inventors: Niko Canner, New York, NY (US); Roopa Unnikrishnan, New York, NY (US); Laura Lee, New York, NY (US)

Correspondence Address: Jonathan S. Caplan, Esq., Kramer Levin Naftalis & Frankel LLP, 919 Third Avenue, New York, NY, 10022, US

(73) Assignee: KATZENBACH PARTNERS LLC

(21) Appl. No.: 09/975,689

(22) Filed: Oct. 11, 2001

Related U.S. Application Data
(60) Provisional application No. 60/239,612, filed on Oct. 11, 2000.

(51) Int. Cl. G06F 7/00

(52) U.S. Cl. 707/100

(57) ABSTRACT

A system and method allows a group or individual to receive highly individualized feedback. Responses to queries relating to a performance area are used with multiple and often interdependent rules (e.g., mathematical formulae) to provide feedback directly based on the responses. Because most of the rules are linked to particular pieces of feedback, and the results of some of the rules are dependent on the results of other rules or multiple responses, variances in the responses to the questions yield different assessments (e.g., different feedback is provided). As every piece of feedback corresponds to a rule that has been satisfied, the assessment is highly sensitive and attuned to the responses that are given to the assessment queries.

### RELATED APPLICATIONS

This application claims the benefit of U.S. Provisional Patent Application No. 60/239,612, filed Oct. 11, 2000, which is hereby incorporated by reference.

### FIELD OF THE INVENTION

The present invention relates to a system and method id for automated or computerized assessment of groups or individuals. More particularly, the system and method facilitate the performance of a highly tailored assessment by using responses to a series of inquiries as inputs to numerous rules, some of the rules being interdependent. The responses can be those of an individual to a series of inquiries, or those of multiple group members providing varied responses to the questions in a single survey. Feedback is provided based on rules that are satisfied: every potential piece of feedback is associated with a rule, and only those pieces of feedback associated with a satisfied rule are delivered to the user. As a result, highly specific and individualized assessments can be performed, providing feedback that is uniquely tailored based on the specific responses of the user(s).

### BACKGROUND INFORMATION

Methods and systems for providing feedback are well-known and have been used in various contexts for years. One of the most basic forms of such systems is a simple self-assessment questionnaire, such as is often found in magazines. For example, self-assessment questionnaires have been used for determining job satisfaction or relationship compatibility. These questionnaires ask the test-taker a series of questions and assign numeric values for each answer. Answering a question in a positive manner may result in a single point. Answering the same question in the negative could result in zero points. Answers from the test-taker could also be obtained based on a scale, such as a five point scale. The poles of the scale correspond to answers such as strongly agree and strongly disagree. The center of the scale represents a neutral opinion. These and other methods of scoring are well known in the art.

Once a test-taker answers all of the questions, the corresponding numeric values of all the answers are summed, and the result is compared with a table of results, thus providing the test-taker with feedback. For example, the results may specify that if the test-taker scored anywhere in a first range (e.g., from zero to ten), then X is true with X being a first assessment or opinion. If the test-taker scored in a second range (e.g., between eleven and twenty), then Y, a different assessment is provided. Such an approach, which groups ranges of scores, however, inherently does not provide as personalized and detailed an analysis as may be desired by the test-taker. For example, using this method, all users who perform within a certain similar range will receive the same feedback, regardless of whether they answered specific questions differently from each other.

With the advent of modern technology such as computers and the Internet, many of these questionnaires have become automated and are now administered over a variety of media, such as websites and telephones. For example, U.S. Pat. No. 5,909,669 discloses a knowledge worker productivity assessment system (10) which includes a database (12, 14, 16) containing survey data (15) generated using a knowledge worker productivity assessment framework (2). A benchmark database (18) contains benchmark values. A retriever (20) is coupled to the databases (12, 14, 16, 18) to retrieve selected survey data (15) and benchmark values. A calculator (38) is coupled to the retriever (20) and generates a comparison value (39) using the selected survey data (15). A relator (40) compares the comparison value (39) to a selected benchmark value to generate a knowledge worker productivity assessment.

A drawback of the above-described system is that the assessment can only provide a score, without being able to provide a meaningful, individualized interpretation of such things as what that score means, why specifically you received that score, or what steps you should take to improve. In addition, most traditional assessments place the user into one of a limited number of predefined categories and provide feedback that applies to anyone placed in that category. For example, the traditional self-assessment questionnaire gauges results and provides feedback based upon a static table of results. One disadvantage of this example is that such static results and feedback may not represent the realities of the situation, and what is desirable in one situation may not be desirable in another situation.

### SUMMARY OF THE INVENTION

The present invention provides a system and method that allow a group or individual to receive highly individualized feedback. According to an exemplary embodiment of the present invention, a group or individual responds to statements or questions relating to a performance area. The statements or questions also can relate to one or more variables, such as team performance variables (e.g., clear objectives and communication). The performance area can relate to any topic for which an assessment of an individual or group could be helpful. The responses to these queries are used with, for example, multiple and often interdependent rules (i.e., mathematical formulae) to provide feedback directly based on the responses. These rules also could be used to generate a score for a particular variable. Significantly, however, because most of the rules are linked to particular pieces of feedback, and the results of some of the rules are dependent on the results of other rules or multiple responses, variances in the responses to the questions yield different assessments (i.e., different feedback is provided). As every piece of feedback corresponds to a rule that has been satisfied, the assessment (which includes all of the feedback) is highly sensitive and attuned to the responses that are given to the assessment queries.

### BRIEF DESCRIPTION OF THE DRAWINGS

The accompanying drawings, which are incorporated in and constitute a part of the specification, illustrate an exemplary embodiment of the present invention.

FIG. 1 is a block diagram of the system for computerized assessment according to an exemplary embodiment of the present invention;

FIG. 2 is a block diagram of the assessment computer for use in the present system of computerized assessment in accordance with an exemplary embodiment of the present invention;

FIG. 3 is a flowchart illustrating the methodology of the system for computerized assessment according to an exemplary embodiment of the present invention;

FIG. 4 is a detailed graphical representation of the feedback according to an exemplary embodiment of the present invention.

### DETAILED DESCRIPTION

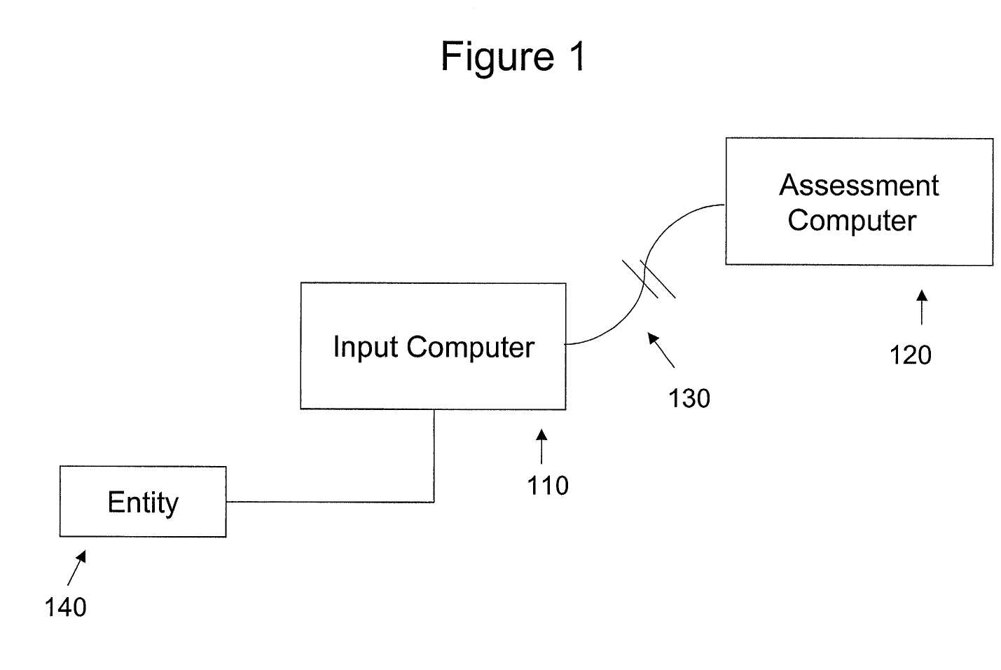

FIG. 1 illustrates a system for conducting computerized assessments in accordance with an exemplary embodiment of the present invention. The system 100 features, for example, an input computer 110, an assessment computer 120 and communications link 130. Input computer 110 interfaces with an entity 140 desiring computerized feedback or advice. For example, entity 140 can be an individual desiring feedback on goal-setting, a company interested in learning on how it can improve company morale (e.g., via a number of employees from a particular company completing an assessment), or a group trying to improve group dynamics (e.g., via a number of members of a group, each completing an assessment). Input computer 110, such as a personal computer or other suitable microprocessor based device, allows entity 140 to respond to statements or questions being posed, and to also receive feedback.

Assessment computer 120, described in more detail below, can perform the analyses on the entity's responses to implement the rules-based analysis. Input computer 110 and assessment computer 120 are electronically connected through, for example, communications link 130. Communications link 130 can include, for example, any type of communications means used to allow electronic components to communicate with each other. These means include, but are not limited to, the Internet, a local area network, a wide area network, a direct modem link, a virtual private network, a fiber optic link and wireless communications. Alternatively, the analyses described herein t0 can be performed on another computer system, such as input computer 110 or some other suitable distributed computing system, and the results provided for display to entity 140.

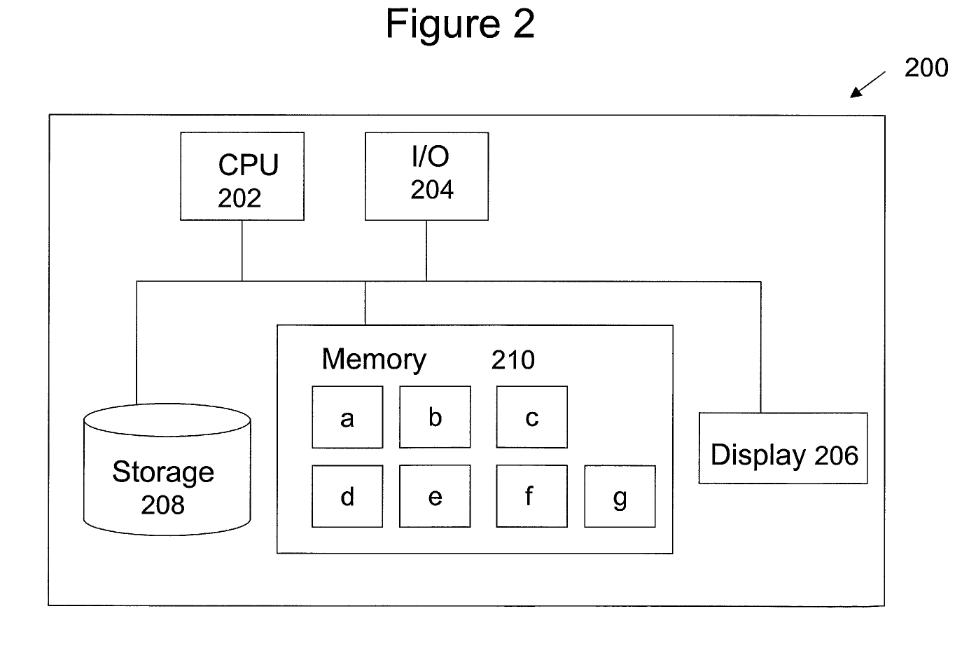

FIG. 2 illustrates an assessment computer for use in an exemplary embodiment of the present invention. Assessment computer 200 can be a single computer, e.g., a server, or a network of computers. For example, assessment computer 200 can be a conventional microprocessor-based server such as ones manufactured by SUN MICROSYSTEMS or INTERNATIONAL BUSINESS MACHINES. In an exemplary embodiment of the present invention, a single computer is used for the assessment computer 200. As shown in FIG. 2, assessment computer 200 includes, for example, central processing unit 202, input/output means 204, display 206, storage device 208, and memory 210. All of these components are electronically connected through, for example, a bus 212.

Memory 210 includes various modules to implement the computerized assessment according to an embodiment of the present invention. For example, memory 210 can include an input module 210a, a formula module 210b, an analysis module 210c and a report module 210d. In alternative exemplary embodiments of the present invention, memory 210 also can include a query edit/create module 210e and a rule edit/create module 210f as well as a variable edit/create module 210g. The modules include, for example, software programs to be executed by CPU 202 and can be written in any conventional programming language. Although the modules are described individually, they may be combined as a single module or in any other suitable configuration as known in the art.

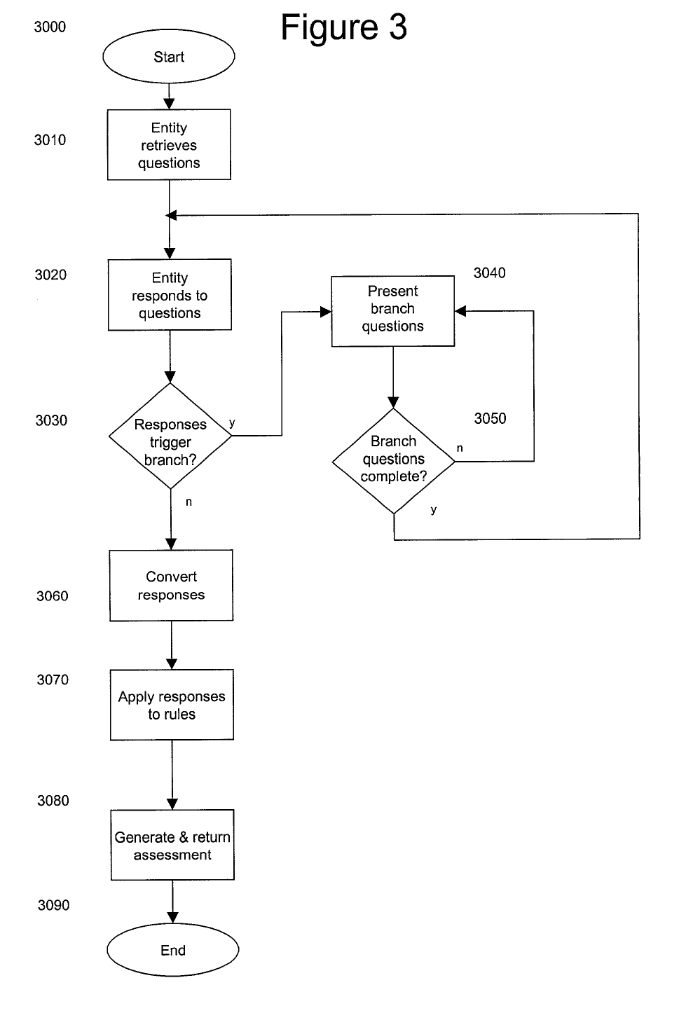

Input module 210a is responsible, for example, for providing queries and soliciting responses from the entity participating in the assessment. Any suitable method for querying the entity 140 can be implemented. For example, input module 210a can have surveys or questionnaires stored within that are directed to topics within a performance area. Alternatively, the survey or questionnaire can be stored in a database of storage medium 208. The performance area can be topic about which the entity is interested in receiving feedback. For example, performance areas for groups may include goal-setting, teamwork or enhancing morale. For individuals, performance areas may be managing finances, better investing, or stronger relationships. The questions or inquiries in an assessment for a performance area can be conveyed in any of a number of ways, such as web page forms, cgi-script forms, drop down lists, electronic mail and the like. In addition, an embodiment of the present invention can include an assessment using a sequence of queries which are presented based on certain responses being provided to other queries of the assessment, as described further with regard to FIG. 3.

The various queries contained in input module 210a or storage medium 208 can be organized (e.g., grouped) by, for example, the type of assessment to be performed. Thus, there can be a set of queries for an individual assessment and a different set of queries for group or team assessments. Further aggregation of queries can be performed as is suitable for the purpose of a particular assessment. Query edit/create module 210e can allow additional queries to be created by, for example, a system administrator or uploaded from an external source. As will be appreciated by those skilled in the art, changes to existing queries or addition of new queries also can be performed via query edit/create module 210e, either on-line or from a storage medium.

Formula module 210b includes, for example, a plurality of rules, which use the responses received by the input module 210a. Alternatively, the plurality of rules can be stored in a AS database of storage medium 208. The rules can be, for example, mathematical formulae or algorithms. The input(s) for each individual rule can be either one or more responses to particular statements or questions and/or outputs from other rules and/or scores for particular variables or derived quantities. A variable can be formed, for example, by aggregating and/or averaging and/or using the standard deviations of the responses to several statements or questions and/or weighting the responses to particular statements or questions and then using these calculated values as input for a rule (or simply choosing to display the derived quantity for illustrative or informational purposes). Variable edit/create module 210g allows variables or other desired quantities to be created or modified by, for example, a system administrator or uploaded from an external source, whether on-line or from a storage medium.

The output for all of the rules can be, for example Boolean-based, that is, either true or false. A piece of potential feedback, such as a text statement, can be associated with a rule. According to an embodiment of the present invention, all rules are evaluated, and when a rule is satisfied (and if it is associated with a piece of feedback), that piece of feedback is displayed. This means that each piece of feedback provided to the user is determined by its own specific rule.

The various rules contained in formula module 210b or storage medium 208 can be organized (e.g., grouped) by, for example, the type of assessment to be formed. Thus, there can be a set of rules for an individual assessment and a different set of rules for group or team assessments. Further aggregation of rules can be performed as is suitable for the purpose of a particular assessment. Rules edit/create module 210f also can allow additional rules to be created by, for example, a system administrator or uploaded from an external source. As will be appreciated by those skilled in the art, changes to existing rules, via rule edit/create module 210f, or addition of new rules can be performed on-line or from a storage medium.

Analysis module 210c applies the responses to queries as well as variable scores to all rules applicable to the survey and then identifies the feedback that corresponds to each rule which is satisfied. The various feedback items associated with a satisfied rule can be stored in analysis module 210c or in a database of storage medium 208. Using the plurality of feedback items, an assessment performed according to an embodiment of the present invention generates highly tailored and individualized feedback in which each piece of feedback is based on one or more particular responses of an individual, thus ensuring the applicability and relevance of the feedback.

According to an embodiment of the present invention, particular patterns can be identified which can lead to feedback relevant to specific performance areas. For example, analysis module 210c may be able to pinpoint specific strengths and weaknesses based on rules designed to identify patterns from responses to various questions or from variable scores. As another example, the system could deliver a piece of feedback related to an ability to involve others in the decision-making process but an inability to facilitate consensus-building, based on a respondent's answers to a combination of specific and varied questions. This analysis procedure is described in more detail below.

Report module 212d provides the results of the analysis to the entity. The analysis (e.g., the feedback and/or visual displays based on the feedback) can be displayed on a monitor or printed on a printer in conventional ways as are known in the art.

FIG. 3 illustrates a flowchart depicting a method of implementing a system for computerized assessment in accordance with an exemplary embodiment of the present invention. The statements or questions, rules and results depicted in illustrating the method are examples and are not intended to limit the scope of the present invention in any manner.

At 3000, a user starts the assessment process, whether for an individual assessment or as part of a group assessment. For example, the user can go to a central testing facility or log onto a host web site via a network connection, such as the Internet, and initiate the desired assessment. At 3010, the user is presented with a set of statements or questions. For example, the questions for the assessment can be conveyed to the input computer 110 through the Internet from a central location, such as the host server of the assessment provider. Table 1 below shows a set of sample statements or questions presented to a user for an assessment related to group dynamics.

Various formats can be used to respond to a statement or question. For example binary answers can be used, such as yes/no, true/false, and agree/disagree. Alternatively, multiple choice answers that allow for greater sensitivity can also be used. For example, a five-point scale representing strongly disagree, disagree, neutral, agree and strongly agree can be implemented.

TABLE 1

| Statement/ | |
|---|---|
| Question No. | Statement/Question |
| 24 | There is a formal statement of the group's objectives |
| 25 | Group members have an inconsistent understanding of |
| | objectives |
| 26 | Objectives are tied to dates and measures |
| 27 | Each member can articulate in what areas the group has |
| | met and failed to meet objectives |
| 28 | I have very clear criteria (qualitative or |
| | quantitative) to judge my success |
| 29 | Confusion regarding overall objectives has slowed |
| | problem solving or implementation |
| 30 | My objectives aren't always clear |
| 31 | The group has a clear mission, distinct from the |
| | mission of others in the organization |
| 32 | The group has defined small wins along the way to an |
| | overall goal |

Each statement or question has an identifier such as a number. Each statement or question can also be associated with a particular topic within a performance area or more than one topic within the performance area. For example, a particular statement may relate to the entity's need to improve performance in a specific area. For example, Statement 32's topic may be goal setting or creating a vision for a group. The response to a statement can be either positive or negative or an intermediate value (e.g., strongly agree or strongly disagree).

At 3020, the user responds to the statement or questions. In an embodiment of the present invention, the series of statements or questions presented to the user can use a “branching” concept. For example, after a response is received, it can be determined if the response triggers a particular line of additional queries, as shown in FIG. 3 at 3030. If the response does not trigger an additional sequence of queries, process continues at 3060. This process could be performed, for example, for each response provided in the assessment before the next statement or question is presented to the user.

If the response triggers an additional sequence of statements or questions for the user, then at 3040 the additional statement or question is presented and at 3050 it is determined if the additional sequence of queries has been completed. The additional statements or questions are presented until completed and then the process continues at 3060. The responses to the assessment can be stored in storage medium 208 or memory 210 for further use as necessary or desired.

At 3060, the responses are converted to numerical values, if necessary and if they are not already numerical. Each possible response to a statement or question has a value, for example a numerical value, associated with it. For example, in a binary system, one answer may receive a “one” and the other may receive “zero.” On a five-point scale, each answer may represent −2, −1, 0, 1 and 2. In an embodiment of the present invention, the processed responses can be used to generate any variable values or derived quantities desired for the assessment.

At 3070, the converted responses are applied to the assessment's rules. It also can be determined if any such variable or derived quantities are to be created from the responses provided by the user. For example, the responses to various statements or questions can be aggregated, averaged and/or weighted or standard deviations could be gathered to create particular types of measurement values (e.g., certain responses may be sufficiently related to generate a useful variable or derived quantity if properly combined). If desired or appropriate, negative weighting values can be used.

Thus, responses to the statements or questions, as well as any additional variables or derived quantities that have been generated, can be used as inputs to at least one rule in the formula module 210b. If feedback is for a group rather than an individual, the average, standard deviation or other collective measures of responses can also be used as input. For illustrative purposes only, Table 2 shows an exemplary partial list of rules that can be used to analyze the responses listed in Table 1. Such rules would be stored in the formula module 210b.

TABLE 2

| Rule ID | Rule | Feedback |
|---|---|---|
| 3568 | Q[31] > .5 | The group has very clear objectives and a |
| | | strong sense of identity due to a clear |
| | | consistent group mission distinct from that of |
| | | the rest of the organization |
| 3766 | Q[31] > 0.6 AND | The group's distinct sense of mission and |
| | Q[32] > 0.6 | clear, evaluable intermediate goals help to |
| | | facilitate coordination and communication |
| 3571 | NOT R[3903] AND | Due to an explicit, formal statement of |
| | Q[24] > 0.7 AND | objectives, there is a consistent |
| | Q[25] < −0.7 AND | understanding of objectives across the group |
| | Q[27] > 0 | |
| 3764 | NOT R[3903] AND | Problem-solving and implementation have been |
| | Q[24] > .45 AND | facilitated by a clear and formal statement of |
| | Q[29] < −.45 | group goals |
| 3769 | NOT R[3903] AND NOT | The group's consistent understanding of |
| | R[3764] AND Q[25] < 0 | objectives has helped to smooth problem- |
| | AND Q[29] < 0 | solving and implementation processes |
| 3904 | Q[25] < 0.5 AND | Individual group members are able to clearly |
| | Q[27] > 0.75 AND | articulate where the group succeeds or fails |
| | Q[26] > 0 | because objectives are tied to specific |
| | | deliverables and overall goals are understood |
| | | by all members |
| 3570 | NOT R[3904] AND | By tying objectives to specific deliverables, |
| | Q[26] > 0.6 AND | the group has established clear measures of |
| | Q[27] > 0.6 | the group's successes or shortcomings |
| 3624 | NOT R[3904] AND | Consistent understanding of group goals across |
| | Q[25] < 0.5 AND | the team allows individual group members to |
| | Q[27] > 0.75 | clearly articulate where the group succeeds or |
| | | fails |
| 3621 | Q[26] > 0.6 AND | Clear and explicitly measurable criteria, such |
| | Q[28] > 0.6 AND | as tying objectives to dates and measures, |
| | Q[27] > 0.5 | ensure clarity around evaluation processes |

As shown in the first column of Table 2, each rule has a ruler identifier. In the second column is a mathematical formula associated with each rule identifier. The formula can be, for example, Boolean operations that result in either a true or false condition. If all of the conditions specified in the formula are satisfied, then the result is true. For example, in order for Rule 3621 to be true, the answers for questions 26, 27 and 28 must all be greater than 0.6, 0.5, and 0.6 respectively. Note that for this rule, all of the inputs were the responses for the questions posed to the entity. An input for a rule can also be the output from another rule. Thus, some or all of the rules can be interdependent with each other. For example, for Rule 3624 to be satisfied, then the output of Rule 3903 must be false and the results to questions 28 and 27 must be greater than 0.6 and 0.5 respectively. If the output to a particular rule is true, then the corresponding feedback is incorporated into the assessment. The rules thus “analyze” the responses to the questions to generate, for example, both positive and negative feedback to be provided to the user.

At 3080, the assessment result, which is a compilation of all the feedback obtained from the rules analysis, is returned to the user or entity. The feedback can be returned to the entity responsible for inputting the responses to the questions or another entity. For example, if an employee answers the questions, then the feedback may be returned to the employee's manager or supervisor. The process ends at 3090.

Depending on the responses provided by the user (or the cumulative averaged responses provided on behalf of an entity), the application of the responses to the rules and the resultant feedback, the feedback returned to the entity may look like that as shown in Table 3. As described below, additional embodiments of the present invention can provide visual displays of the feedback or displays based on, related to or supplementing the feedback. Also according to an embodiment of the present invention, the feedback can include links (e.g., hyperlinks) or identification of additional information or resources related to the particular feedback point and thus correspondingly determined to be applicable to the user based on the satisfaction of a unique rule. Any such link makes additional resources available to the users to further supplement or reinforce the feedback point, such as relevant websites, business journal articles or other media sources. What this technology then uniquely enables is for any of potentially hundreds or thousands of management tools to be recommended and linked to directly, based upon a targeted assessment of the user's business need. This enables a corporation to manage a broad set of resources related to training and organizational effectiveness in ways that ensure individual managers access what they most need when they need it.

TABLE 3
Feedback

The group's distinct sense of mission and clear, evaluable
intermediate goals help to facilitate coordination and
communication
Due to an explicit, formal statement of objectives, there is a
consistent understanding of objectives across the group <Link 1>
The group's consistent understanding of objectives has helped to
smooth problem-solving and implementation processes
Consistent understanding of group goals across the team allows
individual group members to clearly articulate where the group
succeeds or fails <Link 2>
Clear and explicitly measurable criteria, such as tying objectives
to dates and measures, ensure clarity around evaluation processes

The following is an example illustrating use of an exemplary embodiment of the present invention and is not meant to limit the scope of the present invention.

A team is interested in determining how it can improve its group dynamics to efficiently complete a project to which it is assigned. The present invention enables the team members to obtain feedback related to the actions/approach that would help them meet this specific business need. For example, the assessment poses questions about both the particular challenge or project for which the group is responsible (i.e., the business problem), as well as the current workings (e.g., group communication processes, accountability structures) of the team. The assessment then evaluates the team's responses to the questions, using them as input to deliver, for example, feedback first about the type of business problem and how the group should be best structured to address this problem, as well as feedback about specific implications for how the team could improve performance.

In terms of assessing the type of business problem and determining the way the group should be structured, statements or questions related to the type of leadership needed for the group to be successful can be posed. Some statements or questions could focus on the need to integrate the work of the individual team members. Other statements or questions could be directed at the type of coordination needed, such as a hierarchical structure versus a flat structure with various members being responsible for accomplishing the team's goals.

Such statements and questions, along with their corresponding responses, also could be used to calculate certain variables (also referred to as comparative indicators) or special derived quantities that are of interest for the assessment. The two comparative indicators of interest in this example could be the level of integration across individual team members and the type of coordination required. Some of the statements or questions within the assessment are determined to be relevant to one or both of the comparative indicators; others may be relevant to other comparative indicators. One way to create the comparative indicators is to use a rule with weights assigned to the quantitative values of certain responses, as illustrated in Table 4 below. This lends itself to a “score” computed via a linear formula of responses and weights, as in Table 4, but the formulas need not, in general, be linear.

TABLE 4

| | Comparative Indicator 1 | | | | Comparative Indicator 2 | | |
|---|---|---|---|---|---|---|---|
| | (Level of Integration) | | | | (Type of Coordination) | | |
| | | | Weighted | | | | Weighted |
| | Value | Weight | Value | | Value | Weight | Value |
| Response 1 | 2.0 | 1 | 2.0 | Response 7 | −1.0 | 1 | −1.0 |
| Response 2 | 0.0 | 1 | 0.0 | Response 8 | −2.0 | 1 | −2.0 |
| Response 3 | −1.0 | 2 | −2.0 | Response 9 | 1.0 | 2 | 2.0 |
| Response 4 | −1.0 | 1 | −1.0 | Response 10 | 0.0 | 1 | 0.0 |
| Response 5 | −2.0 | 1 | −2.0 | Response 11 | 1.0 | 2 | 2.0 |
| Response 6 | 0.0 | 2 | 2.0 | Response 12 | −1.0 | 2 | −2.0 |

| | | |
|---|---|---|
| Total¹ | −1.0 | −1.0 |

¹ This could be re-scaled linearly or otherwise to yield the comparative indicator score

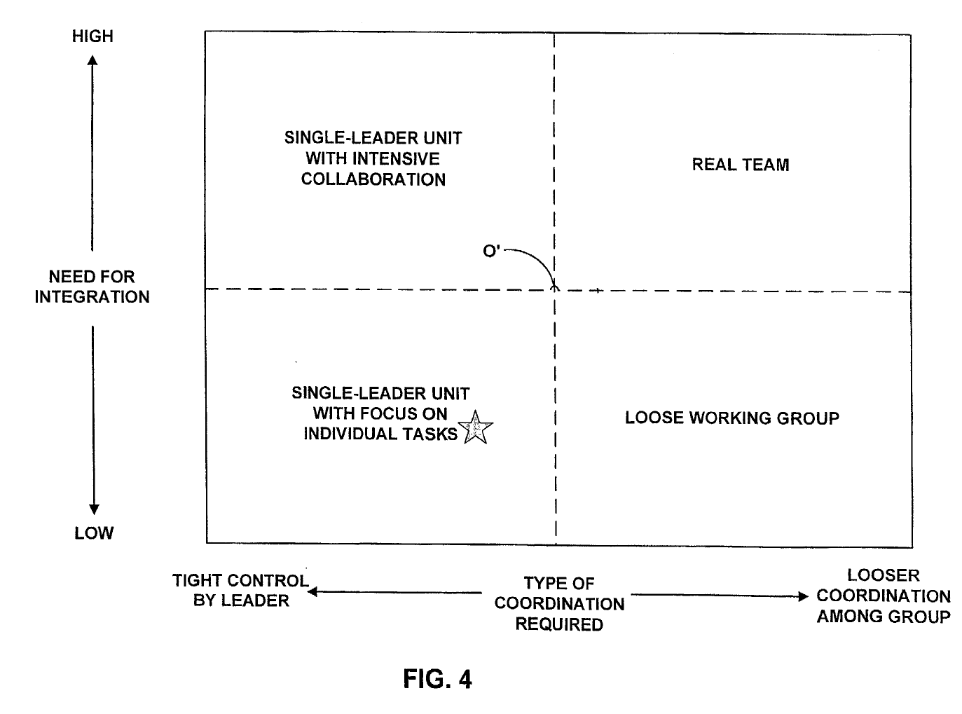

FIG. 4 illustrates the various potential group structures for this team, and how the comparative indicators could be used to determine its ideal structure. For example, each potential group structure is represented by one of the four quadrants on the display: (i) single-leader unit with intensive collaboration, (ii) real team, (iii) single-leader unit with focus on individual tasks, and (iv) loose working group. Comparative indicator 1 (the y-axis) represents the level of integration of the group (from high to low), and comparative indicator 2 (the x-axis) represents the type of coordination used by the group (from tight control by the leader to looser coordination among group) based on responses provided to the assessment.

The four potential situations are related to the comparative indicators as follows. Real teams usually use a high level of integration with members coordinating their activities in a more bottom-up way and shifting leadership. Single leader units, on the other hand, are usually closely controlled by the leader, and may either be highly integrated (if directed by the leader), or may require individuals to address separate tasks. Loose working groups require little integration and the leader is more a coordinator than a director.

It should be understood that more than two comparative indicators may be used, in which case a multivariate analysis could be employed. It should also be understood that more than four partitions in the plane may be used, even when only two comparative indicators are employed. In this case, the ideal group structure is found in quadrant 3 (i.e., single-leader unit with focus on individual tasks) based on the values of comparative indicators 1 and 2.

Beyond just determining the user to have a specific ideal group structure and displaying that ideal structure graphically, however, the system also uses the rules system described earlier to provide highly tailored feedback to the user. Table 5 illustrates a range of potential feedback and corresponding rules (only a portion of which are used in the exemplary table) that could be applicable to this team.

TABLE 5

| Rule ID | Rule | Feedback |
|---|---|---|
| 1001 | V[1] > = 0.5 And | A Real Team |
| | V[2] > = 0.5 | |
| 3853 | R[1001] And (Q[6] < = | The best leadership solution is to shift leadership to |
| | 0.2 And Q[11]< 0.7 | the member with the best expertise for the problem at |
| | And Q[17] < .5) | hand. Given the nature of the team's challenge, a |
| | | reduction in top-down authority is unlikely to put |
| | | performance at risk |
| 3852 | R[1001] And (Q[6] < = | Tight top-down leadership may generate resentment or |
| | 0.2 And Q[11] < 0.7 | ill-will within the group |
| | And Q[17] < .5 And | |
| | Q[19] > 0.75) | |
| 1008 | R[1001] And | One or more individuals will need to take on the role |
| | (Q[22] > 0.5 And | of a strong project manager role to manage complex |
| | Q[18] > 0.6) | deliverables and dependencies. This strong |
| | | coordination role need not impair the group's ability |
| | | to keep leadership roles flexible |
| 1009 | R[1001] And | The teaming effort must either be accelerated or the |
| | (Q[13] < = −0.4 And | team approach used selectively where consistent with |
| | Q[16] < −0.4) | requirements for speed. Dynamic leadership is required |
| | | to ensure that results are delivered on schedule |
| 1160 | (V[1] < 0.5 And | “Traditional” Single-Leader Unit |
| | V[2] < 0.1) Or | |
| | (V[1] < 0.1 And | |
| | V[2] > = 0.1 And | |
| | V[2] < 0.5) | |
| 1161 | R[1160] And (TRUE) | This group can be classified as a “traditional” Single |
| | | Leader Unit, since strong top-down leadership is the |
| | | dominant approach needed to manage results and get |
| | | work done |
| 1166 | R[1160] And | Unstructured creative problem-solving must be |
| | (Q[12] > 0.6 And | restricted to specific issues where it will have the |
| | Q[17] > 0.6 And | greatest impact. Where possible, tasks must be closely |
| | Q[14] > 0.7) | planned and delegated to ensure that the group stays |
| | | on-track in a sensitive environment |
| 1167 | R[1160] And | Given the structured project plan, the group's leader |
| | (Q[14] > 0.7 And | or core group should plan collaborative creative |
| | Q[18] > 0.6 And | problem-solving sessions only for the tasks that most |
| | Q[20] > 0.7) | require creative solutions |
| 1172 | R[1160] And | A structured working approach with standard processes |
| | ((Q[12] > 0.5 OR | will facilitate information-exchange and ensure |
| | Q[17] > 0.5) And | collaboration occurs when most essential, allowing the |
| | Q[7] > 0.75 And | group to remain within the constraints of a sensitive |
| | Q[9] < −0.5) | environment |
| 3897 | R[1160] And | The group's leader is more of a coordinator than a |
| | ((Q[12] > 0.5 OR | director. Given the sensitivity of the project, the |
| | Q[17] > 0.5) And | group's sponsors and core group must play a larger |
| | Q[6] < −0.5 And | part in setting the direction and agenda for the group |
| | Q[11] < −0.75) | |

In a traditional assessment, one would not be able to vary the diagnosis and delivery of advice at the level of the specific actions that should be taken based on the business situation. One would expect a series of set, universal feedback to be delivered (e.g., recommendations prescribed) upon determined placement into a specific category (e.g., “Your group should be structured as a single-leader unit, therefore, you need to have one leader who makes top-down decisions. It will not be productive to have shifting responsibilities.”). As shown in Table 5, however, each piece of feedback has its own particular rule or condition that indicates its relevance to the situation at hand. If all of the conditions specified in a formula are satisfied, then the result is a “true” statement and the piece of feedback will be delivered to the user.

Thus, feedback varies significantly according to which structure has been determined to be ideal for the group. Specific comments about the nature of the ideal group structure and about how to proceed are determined independently from the identification of the ideal group structure itself. Rule 1166, for example, makes a specific recommendation that unstructured creative problem-solving should be used in a focused way and tasks should be carefully planned, based on the overall need for integration and type of coordination scores and recognition of the fact that the consequences for failure are severe (e.g., based on question 12), the group faces a sensitive environment (e.g., based on question 17) and that the group can only succeed by creating something fundamentally new to the organization (e.g., based on question 14). In addition to an ideal situation being identified, elaborate and customized pieces of feedback, based on or expanding on the identified situation, are provided. This example demonstrates that the present invention enables the construction of an unlimited number of business factors upon which advice on actions for improvement can depend.

The following is another example illustrating use of an exemplary embodiment of the present invention and is not meant to limit the scope of the present invention.

One may use an assessment of a business problem to identify an ideal model, then locate and measure gaps between this ideal approach and the approach currently in use. Each one of these gaps could result in an implication for action, with potential performance improvement associated with making a change. Again, certain responses or comparative indicators could then be used to determine an ideal situation, and comparative indicators can also be used to determine the current situation, that is, how the individual or entity is currently performing. This current situation could then be compared to the ideal situation, yielding specific feedback based on this comparison according to an embodiment of the present invention.

Table 6 contains sample rules that are based on the difference between an ideal and a current situation, with both elements determined by the team's answers. For example, V[7] represents the group's current score on an indicator of team performance, e.g., collective work product. LO[7] represents the lower range of the optimal score for this indicator and MO[7] represents the midpoint of the range for the optimal score for this indicator, where the optimal range is determined by correlation with another indicator, e.g., need for integration of tasks. The system according to an embodiment of the present invention is able to use these different comparative indicators (V[7] to represent current score in the dimension of collective work product, and LO[7] and MO[7] as indicators of optimal score in the dimension of collective work product) to make very specific comments about the group's current state and recommendations for future improvement.

TABLE 6

| Rule ID | Rule | Feedback |
|---|---|---|
| 1801 | V[7] > = LO[7] AND | The group has put significant effort into developing |
| | MO[7] > 0.6 | collective work products and shared performance goals, |
| | | in alignment with the performance challenge. The |
| | | resulting sense of integration can he utilized to |
| | | facilitate cooperative efforts and to ensure the |
| | | development of a cohesive project vision |
| 1835 | V[7] < LO[7] AND | The group must focus on a truly collaborative |
| | MO[7] > 0.6 | collective work product to ensure that the talents and |
| | | energy of all are utilized fully in addressing the |
| | | challenge. To date, the group appears to have made |
| | | insufficient investments in determining where |
| | | collective focus is required and developing an overall |
| | | vision, goals and processes |
| 1863 | R[1835] And | Group members have not set common targets because they |
| | (Q[82] < 0.4 and | are not being united by wider belief systems or by |
| | q[65] < 0.2) and not | strong emotional commitments to the group challenge. |
| | R[1837] and not | To remedy the situation, the group leader should take |
| | R[1848] and not | a lead in identifying shared beliefs, creating |
| | R[1859] | performance goals and communicating them to the group |
| 1837 | R[1835] And (V[2] < | Given the need for collaboration, the group leader |
| | −0.5 and V[7] < 0.5) | must focus on facilitating cooperative efforts through |
| | | the identification or creation of joint work products |
| | | and the development of shared performance goals and |
| | | basic vision |

These sample rules illustrate the level of specificity possible in this situation: comparative indicators measuring ideal and current performance are compared to provide a very specific diagnosis of the group's situation. For example, if Rule 1801 is satisfied as a true statement, feedback will be delivered to illustrate that the group has invested in developing collective work products and that this was in fact a useful endeavor, in line with what the business requirements demand. Different scores for the comparative indicators might instead make Rule 1835 satisfied as a true statement, which would then deliver the diagnosis that the group has not invested as it should in creating a collective work product. The determination, for example, that the group's level of investment is below what is necessary, then enables delivery of more specific feedback. Rule 1863, if satisfied, is able to provide a very specific recommendation about why the group is lacking in collective focus, and how the group can remedy its situation. This level of detail and personalization is made possible by the system allowing rules that use responses to questions, other rules, and comparative indicator values as inputs. Thus, because the system according to an embodiment of the present invention allows for individualized feedback based on specific responses, as opposed to static generalized feedback based on an aggregation of responses, more meaningful comments about what a team should do given its specific circumstances of both requirements and current performance can be made.

There is a broad potential range of business problems for which the present invention could be harnessed. For example, there are many applications at the individual level, including but not limited to: assessment of approaches to achieving impact as a leader, maximizing personal effectiveness, development of an effective supervisory approach for specific employees, design of sales approaches to fit the characteristic of specific customers, setting project objectives, project planning, performance assessment, diagnosing barriers to change and developing strategies to surmount them, selection of technologies applicable to specific business problems, and planning for personal and career development. There are also a broad range of applications at the group and organizational level, including but not limited to: assessment of strategies for maximizing the performance of teams and groups, “360-degree” feedback, generation of interview questions to meet the specific situations of job candidates, identification of opportunities to improve the effectiveness of organizational culture, action planning in relation to customer accounts, recommendation of resources to develop organizational competencies, and identification of process reengineering opportunities. While assessments could potentially be developed in any of these areas without this technology, the present invention uniquely enables detailed and targeted recommendations to be made to individuals, groups or organizations based on very large numbers of potential patterns related to their specific business situation.

Thus, while there had been described what are presently believed to be the preferred embodiments of the present invention, those skilled in the art will appreciate that other and further modifications can be made without departing from the true scope of the invention, and it is intended to include all such modifications and changes as come within the scope of the claims as appended herein.

What is claimed is:

1. A method of conducting an assessment, comprising:
presenting a plurality of queries to an entity;
receiving a response to each of the plurality of queries;
applying the responses to a plurality of rules so that each rule has one of a satisfied state and an unsatisfied state, a portion of the plurality of rules being interdependent;
identifying feedback items based on the state of the plurality of rules, each feedback item being associated with at least one of the plurality of rules having the satisfied state; and
transmitting the feedback items to the entity.

2. The method of claim 1, wherein the plurality of queries relate to a performance area.

3. The method of claim 1, wherein the entity is a group.

4. The method of claim 1, wherein the entity is an individual.

5. The method of claim 1, wherein a host computer presents the plurality of queries and transmits the feedback items.

6. The method of claim 1, wherein the plurality of rules include mathematical formulae.

7. The method of claim 1, wherein the plurality of rules include Boolean operations.

8. The method of claim 7, wherein predetermined ones of the plurality of rules use output from other of the plurality of rules.

9. A system for conducting a n assessment, comprising:
a user computer; and
an assessment computer coupled to the user computer via a communications link, wherein the assessment computer includes
a central processing unit (CPU), and
a memory coupled to the CPU, the memory storing computer executable code to be executed by the CPU, the computer executable code
presenting a plurality of queries to an entity,
receiving a response to each of the plurality of queries,
applying the responses to a plurality of rules so that each rule has one of a satisfied state and an unsatisfied state, a portion of the plurality of rules being interdependent,
identifying feedback items based on the state of the plurality of rules, each feedback item being associated with at least one of the plurality of rules having the satisfied state, and
transmitting the feedback items to the user computer.

10. The system of claim 9, wherein the memory includes a query database storing the plurality of queries.

11. The system of claim 9, wherein the memory includes a rules database storing the plurality of rules.

12. The system of claim 9, wherein the memory stores the responses to the plurality of queries.

13. The system of claim 9, wherein the user computer includes a display to display the feedback items.

14. The system of claim 9, wherein the plurality of rules include a Boolean operation, a true condition of the Boolean operation corresponding to the satisfied state and a false condition of the Boolean operation corresponding to the unsatisfied state.

15. The system of claim 9, wherein the communications link includes one of a dialup connection, a wireless network connection, a local area network, a wide area network, fiber optic connection and an Internet connection.

16. The system of claim 9, wherein the memory includes computer executable code identifying an additional set of queries to be presented to the entity as a function of a predetermined response to at least one of the plurality of queries.

17. The system of claim 9, wherein the queries include one of a statement and a question.

18. The system of claim 9, wherein the computer executable code transmitting the feedback items to the user computer includes links to additional resources related to a respective feedback item.

19. The system of claim 18, wherein the links include one of a hyperlink and an identification of an additional resource.

20. The system of claim 19, wherein the hyperlink includes identification of a universal resource locator and the additional resource includes publication.

21. The system of claim 9, wherein the entity includes one of an individual and a group.

22. A method of conducting an assessment, comprising:
presenting a plurality of queries to an entity;
receiving a response to each of the plurality of queries;
applying the responses to a plurality of rules so that each rule has one of a satisfied state and an unsatisfied state, a portion of the plurality of rules being interdependent;
identifying feedback items based on the state of the plurality of rules, each feedback item being associated with at least one of the plurality of rules having the satisfied state; and
transmitting the feedback items to the entity, at least one of the feedback items including a link to an additional resource associated with the feedback item.

23. A method of conducting an assessment, comprising:
presenting a plurality of queries to an entity;
receiving a response to each of the plurality of queries;
applying the responses to a plurality of rules so that each rule has one of a satisfied state and an unsatisfied state, a portion of the plurality of rules being interdependent;
identifying feedback items based on the state of the plurality of rules, each feedback item being associated with at least one of the plurality of rules having the satisfied state; and
transmitting the feedback items to the entity, at least one of the feedback items including a link to an additional resource associated with the feedback item,
wherein the plurality of rules results in at least a first comparative indicator and at least a second comparative indicator, the first comparative indicator representing an ideal situation for the entity, and the second comparative indicator representing a current situation for the entity.

24. The method of claim 23, wherein the first comparative indicator includes two comparative indicators used to determine the ideal situation and the second comparative indicator includes two comparative indicators used to determine the current situation.

25. The method of claim 24, wherein the feedback items include at least one feedback item based on a comparison between in the ideal situation and the current situation.

26. The method of claim 24, comprising displaying a comparison of the ideal situation and the current situation.

27. The method of claim 23, wherein the plurality of queries relate to one of an individual assessment and a group assessment.

28. A system for conducting an assessment, comprising:
an assessment computer adapted to communicate with a user computer via a communications link, wherein the assessment computer includes
a central processing unit (CPU), and
a memory coupled to the CPU, the memory storing computer executable code to be executed by the CPU, the computer executable code
presenting a plurality of queries to an entity,
receiving a response to each of the plurality of queries,
applying the responses to a plurality of rules so that each rule has one of a satisfied state and an unsatisfied state, a portion of the plurality of rules being interdependent,
identifying feedback items based on the state of the plurality of rules, each feedback item being associated with at least one of the plurality of rules having the satisfied state, and
transmitting the feedback items to the user computer.

29. The system of claim 28, comprising a storage medium coupled to the CPU, the storage medium including at least one database and storing the plurality of queries, the plurality of rules and the feedback items.

30. A system for conducting an assessment, comprising
means for presenting a plurality of queries to an entity;
means for receiving a response to each of the plurality of queries;
means for applying the responses to a plurality of rules so that each rule has one of a satisfied state and an unsatisfied state, a portion of the plurality of rules being interdependent;
means for identifying feedback items based on the state of the plurality of rules, each feedback item being associated with at least one of the plurality of rules having the satisfied state; and
means for transmitting the feedback items to the entity.
